(19) United States
(12) Patent Application Publication
(10) Pub. No.: US 2012/0185126 A1
(43) Pub. Date: Jul. 19, 2012

(54) VEHICLE CONTROL SYSTEM DIAGNOSTIC TOOL

(75) Inventors: Shige Wang, Northville, MI (US); Sridhar Ragu, Southfield, MI (US)

(73) Assignee: GM GLOBAL TECHNOLOGY OPERATIONS LLC, Detroit, MI (US)

(21) Appl. No.: 13/009,125

(22) Filed: Jan. 19, 2011

(51) Int. Cl. G06F 7/00

(52) U.S. Cl. 701/32.9; 701/34.2

(57) ABSTRACT

A system includes a source module configured to generate a value related to control of a vehicle component. A destination module is configured to receive the value and implement the value in a control procedure to control the vehicle component. A diagnostic tool is configured to implement a diagnostic language that defines a compatibility relationship between the source module and the destination module. The diagnostic tool can determine whether the value generated by the source module is compatible with the control procedure based on the compatibility relationship. A method includes identifying a value generated by the source module, identifying a characteristic of the value generated by the source module, determining whether the destination module is configured to receive the value from the source module and implement the value in the control procedure, and determining whether the value is compatible with the control procedure given the compatibility relationship.

### TECHNICAL FIELD

The disclosure relates to a diagnostic tool for a vehicle control system.

### BACKGROUND

Passenger and commercial vehicles may have one or more control systems that control the operation of one or more components of the vehicle. Each control system may receive information from, for example, sensors located throughout the vehicle. The control systems may each be implemented via one or more modules generated by a software engineer or developer.

### SUMMARY

An example system includes a source module configured to generate a value related to control of a vehicle component and a destination module configured to receive the value generated by the source module. The destination module is configured to implement the value in a control procedure to control the vehicle component. A diagnostic tool is configured to implement a diagnostic language that defines a compatibility relationship between the source module and the destination module. The diagnostic tool can determine whether the value generated by the source module is compatible with the control procedure of the destination module based on the compatibility relationship defined by the diagnostic language.

An example method of diagnosing errors in a control procedure includes identifying a value generated by a source module and identifying a characteristic of the value generated by the source module. The method further includes determining whether a destination module is configured to receive the value from the source module and implement the value in a control procedure to control the vehicle component. Moreover, the method includes determining whether the value is compatible with the control procedure implemented by the destination module based on a compatibility relationship between the source module and the destination module. The compatibility relationship is defined by a diagnostic language.

### BRIEF DESCRIPTION OF THE DRAWINGS

FIG. 1 is a schematic diagram of a computing device having a diagnostic tool.

FIG. 2 illustrates an example flowchart of a process that may be executed by the diagnostic tool to determine whether values generated by a source module are compatible with a control procedure implemented by a destination module.

FIG. 3 illustrates an example flowchart of a process that may be implemented by the diagnostic tool if a destination module receives values from multiple source modules.

FIG. 4 illustrates an example flowchart of a process that may be executed by the diagnostic tool to determine a priority among multiple control procedures that may be implemented by different destination modules.

### DETAILED DESCRIPTION

A computing device is disclosed that is configured to identify potential errors in real time between modules used to control various vehicle components. The computing device uses a diagnostic tool that implements a diagnostic language. The diagnostic language defines a compatibility relationship between different modules. For instance, the compatibility relationship may define acceptable interactions as well as restricted interactions between two or more modules. With the diagnostic language, the diagnostic tool may be able to identify potential errors in real time between modules that are used to control various vehicle components. The computing device may take many different forms and include multiple and/or alternate components and facilities. While an example computing device is shown in the Figures, the components illustrated in the Figures are not intended to be limiting. Indeed, additional or alternative components and/or implementations may be used.

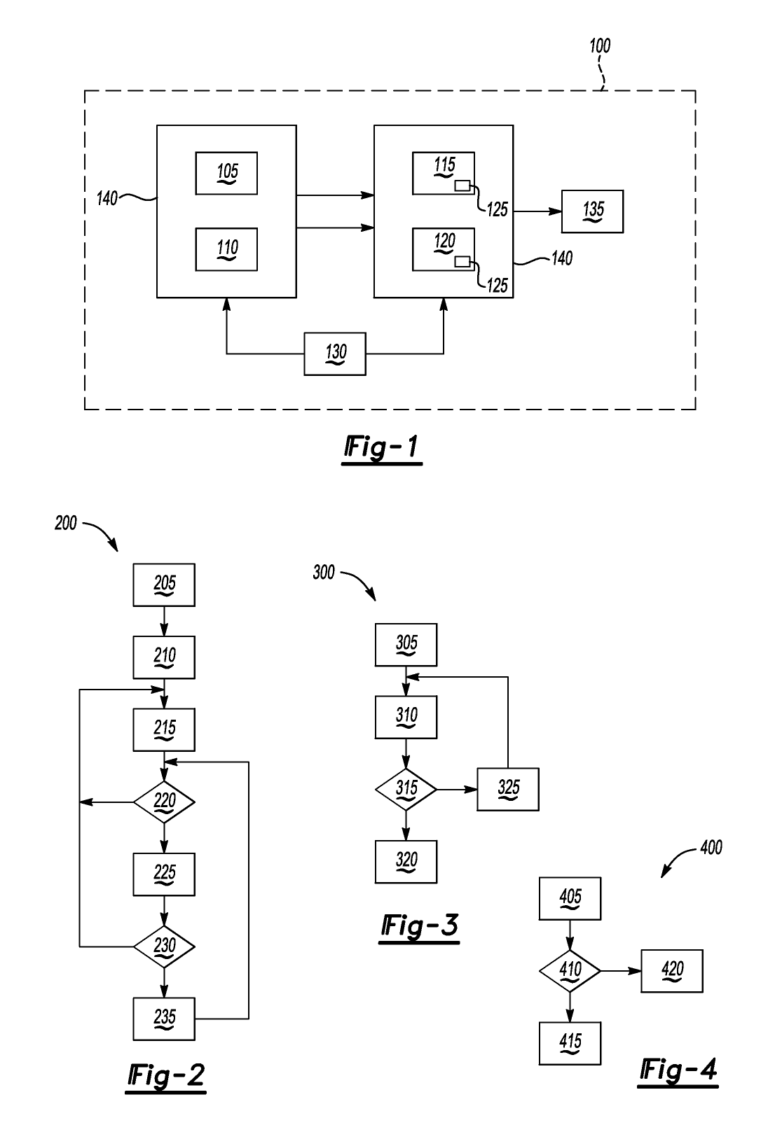

Referring to FIG. 1, a computing device 100 may implement a first source module 105, a second source module 110, a first destination module 115, a second destination module 120, and a diagnostic tool 125. The computing device 100 may further include an input device 130 and an output device 135 to interface with a user, such as a software engineer or developer, who can write and revise the code used in one or more of the modules. Further, the computing device 100 may be used to diagnose control procedures for any passenger or commercial automobile such as a hybrid electric vehicle including a plug-in hybrid electric vehicle (PHEV) or an extended range electric vehicle (EREV), a gas-powered vehicle, a battery electric vehicle (BEV), or the like.

The computing device 100 may include any device configured to employ any of a number of computer operating systems and generally include computer-executable instructions, where the instructions may be executable by one or more computing devices 100. Computer-executable instructions may be compiled or interpreted from computer programs created using a variety of well known programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

The computing device 100 may be configured to present various software modules to a user via, for instance, the output device 135. The output device 135 may include any device configured to display information to the user. As such, the output device 135 may include a display monitor, such as a liquid crystal display (LCD) monitor. Moreover, the computing device 100 may be configured to receive instructions from a user via, for example, the input device 130. The input device 130, therefore, may include a computer mouse or keyboard.

The first source module 105 and the second source module 110 may each be configured to generate one or more values related to control of one or more vehicle components. For instance, the first source module 105, the second source module 110, or both, may be configured to receive signals from one or more vehicle components or sensors disposed about the vehicle and generate values based on the signals received. The values generated by the first source module 105 and/or the second source module 110 may be associated with one or more characteristics. The characteristics may include a type of value, a pattern, etc. The type of value may refer to the mathematical description of the value, e.g., whether the value is an integer, a positive number, a prime number, within a predetermined range, etc. The pattern may be a quality of the configuration of the first source module 105 or the second source module 110 that suggests information about the value. For instance, a value generated by the first source module 105 that is based on a signal received from a speed sensor may suggest that the value represents a velocity. Although two source modules are illustrated in FIG. 1, the computing device 100 may include any number of source modules.

The first destination module 115 and the second destination module 120 may each be in communication with the first source module 105, the second source module 110, or both, and may each be configured to receive one or more of the values generated by the first source module 105, the second source module 110, or both. The first destination module 115 may implement the values received in a first control procedure that may control the operation of one or more vehicle components. The second destination module 120 may implement the values received in a second control procedure that may control the operation of the same or a different vehicle component than the first control procedure. The first and/or second control procedures may be configured to receive values having a specific characteristic (e.g., values of a particular type, pattern, etc.) Although two destination modules are illustrated in FIG. 1, the computing device 100 may include any number of destination modules.

In one possible implementation, the first source module 105, the second source module 110, the first destination module 115, and/or the second destination module 120 may be stored in one or more databases 140 within the computing device 100 and/or in communication with one or more computing devices 100 over, for instance, a network. The user may access and interact with one or more of these modules over the network using the input device 130 and output device 135. Additionally, multiple computing devices 100 may be configured to access each database 140, and thus, multiple users may access and interact with the first source module 105, the second source module 110, the first destination module 115, and the second destination module 120, as well as any other modules stored in the database 140.

The database 140 may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device (e.g., not necessarily the computing device 100 of FIG. 1) employing a computer operating system such as one of those mentioned above, and are accessed via a network in any one or more of a variety of manners. A file system may be accessible from a computer operating system, and may include files stored in various formats. An RDBMS generally employs the known Structured Query Language (SQL) in addition to a language for creating, storing, editing, and executing stored procedures, such as the PL/SQL language.

The diagnostic tool 125 may be configured to help a user of the computing device 100 determine whether there are errors or inconsistencies in the values generated by first source module 105 or the second source module 110 relative to the control procedures executed by the first destination module 115 and the second destination module 120 to control one or more vehicle components. In one possible implementation, the diagnostic tool may implement a diagnostic language that defines a compatibility relationship between different modules, such as the source modules 105, 110 and the destination modules 115, 120. The compatibility relationship may define acceptable interactions as well as restricted interactions between two or more of the source and destination modules 105, 110, 115, and 120. With the diagnostic language, the diagnostic tool may be able to identify potential errors in real time between the modules that are used to control various vehicle components. That is, using the diagnostic language, the diagnostic tool 125 may be configured to determine whether the values generated by the first source module 105 and/or the second source module 110 are compatible with the characteristics of the values used in the control procedures implemented by the first destination module 115 and/or the second destination module 120. In one possible approach, the diagnostic tool 125 may be configured to make such a determination based at least in part on the characteristic of the value generated by the first source module 105 and/or the second source module 110 in light of the compatibility relationship defined by the diagnostic language.

For instance, the characteristic of the value may indicate that the value is an integer. The compatibility relationship may indicate that the value used in one or both of the first and second control procedures must be within a predetermined range. Using the diagnostic language, therefore, the diagnostic tool 125 may be configured to determine if the integer representing the value is within the predetermined range of values required by one or both of the first and second control procedures. If so, the diagnostic tool 125 may determine that the value is compatible with the first and/or second control procedures. However, if the integer representing the value is outside of the predetermined range, the diagnostic tool 125 may determine that the value is incompatible with the first and/or second control procedures. The diagnostic tool 125 may consider other characteristics of the value relative to characteristics of values used by the first and/or second control procedure to determine whether the value is compatible with the first and/or second control procedure.

Additionally, using the diagnostic language, the diagnostic tool 125 may be configured to determine whether the characteristic of one or more of the values generated by the first source module 105 and/or the second source module 110 have changed. For instance, the compatibility relationship may define changes to one of the source modules 105, 110 that may affect the first and/or second control procedures. If so, the diagnostic tool 125 may be configured to identify those destination modules that depend upon the value. The diagnostic tool 125 may be further configured to notify the user of the change to automatically or allow the user to manually make any necessary revisions to the first destination module 115 and/or the second destination module 120 to account for the change.

For example, if the first source module 105 initially outputs a value representing a quantity with units in accordance with the International System of Units (e.g., SI units), the first destination module 115 and the second destination module 120 may be configured to apply the value with SI units in the first control procedure and the second control procedure. If, however, the value is changed (e.g., following a change in the first source module 105 or the second source module 110) to represent a quantity with units in accordance with a system of measurement common in the United States (e.g., US units), the compatibility relationship may identify this change in the units of a value as a restricted interaction so that the diagnostic tool 125 may identify the change in the type of units (e.g., the characteristic of the value) and notify the user to update the first destination module 115 and/or the second destination module 120 accordingly. Alternatively, the diagnostic tool 125 may be configured to, upon selection by the user, automatically convert the value back to a quantity representing SI units or convert the control procedure to accommodate values with US units.

In one possible approach, the diagnostic tool 125 may be configured to determine whether any of the source modules generate values that are not used in any control procedures. For instance, the diagnostic tool 125 may be configured to determine which values generated by the first source module 105 and/or the second source module 110 are received and used by the first destination module 115, the second destination module 120, or both. The diagnostic language via, e.g., the compatibility relationship, may indicate that the source module generating the unused value should be edited or that the unused values should be removed from the source module. Accordingly, if the first source module 105 and/or the second source module 110 are configured to generate an unused value that is not implemented into the first or second control procedures, and thus would not be received by the first destination module 115 or the second destination module 120, the diagnostic tool 125 may be configured to determine that the unused value is unnecessary. The diagnostic tool 125 may present the user with a message indicating that the value is unused so, for instance, the user may consider modifying the first source module 105 or second source module 110 accordingly. The diagnostic tool 125 may be configured to automatically remove the portion of the first source module 105 or the second source module 110 dedicated to generating the unused value, or the diagnostic tool 125 may direct the user to the relevant portion or portions of the first source module 105 and/or second source module 110 so that the user may make any necessary modifications to eliminate the unused value.

The diagnostic tool 125 may be further configured to prioritize multiple control procedures based on the diagnostic language during conflicts. For example, using the diagnostic language, the diagnostic tool 125 may be configured to determine whether the first control procedure and the second control procedure should be used to control the vehicle component based at least in part on, for instance, one or more of the values generated by the first source module 105, the second source module 110, or both. By way of example, the first destination module 115 may implement one of the values generated by the first source module 105 or the second source module 110 in the first control procedure, which may be used for cruise control in a vehicle. The second destination module 120 may implement the same value generated by the first source or the second source in the second control procedure, which may be used for vehicle stability control. In some circumstances, the cruise control system may take priority over the stability control system (e.g., the first control procedure may set the speed of the vehicle despite a speed calculation by the second control procedure to control vehicle stability). However, if the value generated by the first source module 105 or the second source module 110 indicates that the vehicle is navigating a curve in a road, the diagnostic language may indicate that priority should be given to the vehicle stability control (e.g., the second control procedure) over the cruise control system (e.g., the first control procedure). The diagnostic tool 125 may take appropriate action to execute the vehicle stability control procedure over the cruise control system based on the priority indicated by the diagnostic language.

The first source module 105, the second source module 110, the first destination module 115, the second destination module 120, and the diagnostic tool 125 may be provided as software that when, e.g., executed by the computing device 100 provide the operations described herein. Alternatively these and other modules may be provided as hardware or firmware, or combinations of software, hardware and/or firmware. Additionally, the operations of these modules may be provided by fewer, greater, or differently named modules.

FIG. 2 illustrates an example process 200 that may be used by the diagnostic tool 125 to determine whether values generated by the first source module 105 and/or the second source module 110 are compatible with the control procedures implemented by the first destination module 115 or the second destination module 120.

At block 205, the diagnostic tool 125 may identify the values generated by the first source module 105, the second source module 110, or both. For instance, the diagnostic tool 125 may determine which sensors output signals representative of various vehicle attributes to the first source module 105 and/or the second source module 110. The diagnostic tool 125 may use the diagnostic language to identify any values generated by the first source module or the second source module 110 that may be relevant to the first and/or second control procedures.

At block 210, the diagnostic tool 125 may associate each of the values identified at block 205 with one or more characteristics. The diagnostic tool 125 may, using the diagnostic language, determine the characteristic based on the source of a signal (e.g., a sensor) provided to the first source module 105 and/or the second source module 110. Alternatively, the diagnostic tool 125 may determine the characteristic based upon a way in which the first source module 105 and/or the second source module 110 manipulates signals. For instance, a sensor may output a signal to the first source module 105. The first source module 105 may manipulate that signal to generate a value represented by an integer. Thus, the diagnostic tool 125 may identify the value as an integer (e.g., the characteristic of the value).

At block 215, the diagnostic tool 125 may identify the values received by the first destination module 115, the second destination module 120, or both, from the first source module 105 and/or the second source module 110. For instance, the diagnostic tool 125 may, using the diagnostic language, identify the values needed to implement the first and second control procedures, as well as the source (e.g., the first source module 105 or the second source module 110) and/or characteristics of those values. The diagnostic tool 125 may identify the values used in the first control procedure as the values received by the first destination module 115 and the values used in the second control procedure as the values received by the second destination module 120.

At decision block 220, the diagnostic tool 125 may determine whether the values received by the first destination module 115 are compatible with the first control procedure and whether the values received by the second destination module 120 are compatible with the second control procedure. For instance, the diagnostic tool 125 may consider the characteristic of the value identified at block 210 in light of the characteristics of the values used in the first control procedure, the second control procedure, or both, identified at block 215. The diagnostic tool 125 may, for instance, compare the characteristics of the value identified at block 210 in light of the compatibility relationship, which as described above, defines acceptable interactions and restricted interactions between two or more modules. Thus, using the compatibility relationship, the diagnostic tool 125 may determine that the characteristic of the value indicates that the value is represented by an integer and the characteristic of the values used in one or both of the first and second control procedures may include integers within a predetermined range. If the characteristics are the same (e.g., the integer representing the value identified at block 210 is within the predetermined range), the process 200 may return to block 210 to consider other values generated by the first source module 105 and/or the second source module 110, and thus, the diagnostic tool 125 may passively indicate that no error is detected. If the characteristics are different (e.g., the integer representing the value identified at block 210 is outside the predetermined range of values), the process 200 may continue at block 225.

At block 225, the diagnostic tool 125 may notify the user that one or more of the values generated by the first source module 105 and/or the second source module 110 are not compatible with the values needed to implement the first control procedure and/or the second control procedure. For instance, the diagnostic tool 125 may present the user with a message via the display device that indicates that the value generated is incompatible with one or more of the control procedures.

At decision block 230, the diagnostic tool 125 may prompt the user to ignore the message presented at block 225. This way, the user may determine on a case-by-case basis that the inconsistency determined at block 220 is inconsequential to the successful control of the vehicle component using the first or second control procedure. Alternatively, the user may determine that the inconsistency will be cured upon a future revision of the source module that generated the value, and thus, the user can ignore the message with respect to the destination module. The user may indicate his or her preference to the diagnostic tool 125 using the input device 130. If the user chooses to ignore the message, the process 200 may continue at block 215. If, however, the user chooses to address the message, the process 200 may continue at block 235.

At block 235, the diagnostic tool 125 may prompt the user to provide a new value having a characteristic that is compatible with either the first or second control procedure, or alternatively, prompt the user to revise the control procedure to accommodate the characteristic of the value. Moreover, the diagnostic tool 125 may suggest ways for the user to revise either the value or the control procedure and prompt the user to accept or reject such suggestions.

FIG. 3 illustrates an example process 300 that may be used by the diagnostic tool 125 to prompt a user to select among multiple source modules (e.g., the first source module 105 and the second source module 110) to provide one or more values to the first destination module 115 and/or the second destination module 120.

At block 305, the diagnostic tool 125 may identify the multiple sources and the values generated by each source. For instance, the diagnostic tool 125 may, using the diagnostic language, identify a first value generated by the first source module 105 and a second value generated by the second source module 110. The first value and the second value may each be associated with a characteristic.

At block 310, the diagnostic tool 125 may prompt the user to select one of the first source module 105 and the second source module 110. For instance, the compatibility relationship may indicate that only one source identified at block 305 is permissible, and thus, the diagnostic tool 125 may present the user with a message via the display device indicating to the user that the control procedure is configured to receive only one of the first value and the second value and request that the user select between the first source module 105 and the second source module 110. The user may communicate his or her selection to the diagnostic module via the input device 130.

At decision block 315, the diagnostic tool 125 may determine whether the value generated by the first source module 105 or the second source module 110 selected at block 310 is compatible with the control procedure implemented by the destination module based on the compatibility relationship defined by the diagnostic language. If the characteristic of the value is compatible with the control procedure, the process 300 may continue at block 320. If not, the process 300 may continue at block 325.

At block 320, the diagnostic tool 125 may, as dictated by the diagnostic language, update the control procedure implemented by the destination module to include the value generated by the selected source module. Alternatively, the diagnostic tool 125 may direct the user to the appropriate location in the control procedure where the user may manually update the control procedure with the selected value.

At block 325, the diagnostic tool 125 may notify the user that one or more of the values generated by the selected source module are not compatible with the values needed to implement the control procedure. The diagnostic tool 125 may present the user with a message via the display device that indicates that the value generated is incompatible with one or more of the control procedures. The diagnostic tool 125 may further provide the user with an option to revise the control procedure to accommodate the value generated by the selected source module, return to block 310 to select a different source module, or ignore the notification.

FIG. 4 illustrates an example process 400 that may be used by the diagnostic tool 125 to determine a priority among the first control procedure implemented by the first destination module 115 and the second control procedure implemented by the second destination module 120.

At block 405, the diagnostic tool 125 may identify one or more values that are used with the first control procedure implemented by the first destination module 115 and the second control procedure implemented by the second destination module 120. The values identified by the diagnostic tool 125 may be generated by the first source module 105, the second source module 110, or both.

At decision block 410, the diagnostic tool 125 may, using the diagnostic language, make a determination about the value that indicates whether the first control procedure or the second control procedure should be given priority to control one or more of the vehicle components. The diagnostic language may define the instances where one control procedure might be given priority over the other. Accordingly, the diagnostic tool 125 may compare one or more of the values identified at block 405 to a threshold value or a range of values defined by the diagnostic language. Depending on the outcome of this comparison of, for instance, the value relative to the threshold or range of values, the process 400 may continue at block 415 if the diagnostic tool 125 determines that the first control procedure implemented by the first destination module 115 is best suited to control one or more vehicle components or at block 420 if the diagnostic tool 125 determines that the second control procedure implemented by the second destination module 120 is best suited to control one or more vehicle components.

While the best modes for carrying out the invention have been described in detail, those familiar with the art to which this invention relates will recognize various alternative designs and embodiments for practicing the invention within the scope of the appended claims.

1. A system comprising:
a source module configured to generate a value related to control of a vehicle component;
a destination module configured to receive the value generated by the source module and implement the value in a control procedure to control the vehicle component; and
a diagnostic tool configured to implement a diagnostic language that defines a compatibility relationship between the source module and the destination module, wherein the diagnostic tool is configured to determine whether the value generated by the source module is compatible with the control procedure of the destination module based on the compatibility relationship defined by the diagnostic language.

2. A system as set forth in claim 1, wherein the value is associated with a characteristic, and wherein the diagnostic tool is configured to determine whether the value is compatible with the control procedure of the destination module based at least in part on the characteristic of the value.

3. A system as set forth in claim 1, wherein the diagnostic tool is configured to determine whether the value is within a predetermined range.

4. A system as set forth in claim 3, wherein the diagnostic tool is configured to determine that the value generated by the source module is compatible with the control procedure of the destination module if the value is within the predetermined range.

5. A system as set forth in claim 4, wherein the diagnostic tool is configured to determine that the value generated by the source module is incompatible with the control procedure of the destination module if the value is outside the predetermined range.

6. A system as set forth in claim 1, wherein the value is associated with a characteristic, and wherein the diagnostic tool is configured to determine whether the characteristic of the value has changed.

7. A system as set forth in claim 6, wherein the diagnostic tool is configured to set a flag indicating that the characteristic of the value has changed if the diagnostic tool determines that the characteristic of the value has changed.

8. A system as set forth in claim 1, wherein the source module is configured to generate a plurality of values including a first value and a second value, and wherein the destination module is configured to receive the first value.

9. A system as set forth in claim 8, wherein the diagnostic tool is configured to determine whether the destination module is configured to receive the second value.

10. A system as set forth in claim 9, wherein the first value and the second value are each associated with a characteristic.

11. A system as set forth in claim 9, wherein the diagnostic tool is configured to determine that the second value is unnecessary if the destination module is not configured to receive the second value.

12. A system as set forth in claim 1, wherein the destination module includes a first destination module and wherein the control procedure includes a first control procedure, and further comprising a second destination module configured to receive the value from the source module and implement the value in a second control procedure to control the vehicle component, wherein the diagnostic tool is configured to determine a priority of the first control procedure and the second control procedure based at least in part on the value from the source module.

13. A method of diagnosing errors in a control procedure, the method comprising:
identifying a value generated by a source module;
identifying a characteristic of the value generated by the source module;
determining whether a destination module is configured to receive the value from the source module and implement the value in a control procedure to control the vehicle component; and
determining whether the value is compatible with the control procedure implemented by the destination module based on a compatibility relationship between the source module and the destination module, wherein the compatibility relationship is defined by a diagnostic language.

14. A method as set forth in claim 13, wherein determining whether the value is compatible with the control procedure implemented by the destination module is based at least in part on the characteristic of the value.

15. A method as set forth in claim 13, further comprising generating a message to notify a user of the destination module if the value generated by the source module is not compatible with the control procedure implemented by the destination module.

16. A method as set forth in claim 15, further comprising prompting the user to ignore the message.

17. A method as set forth in claim 15, further comprising prompting the user to provide a new value having a characteristic compatible with the control procedure of the destination module.

18. A method as set forth in claim 13, wherein identifying a value generated by a source module includes:
identifying a first value generated by a first source module;
identifying a second value generated by a second source module, wherein the destination module is configured to receive at least one of the first value and the second value;
prompting a user to select at least one of the first source module and the second source module; and
updating the control procedure of the destination module with at least one of the first value and the second value based at least in part on at least one of the first source module and the second source module selected by the user.

18. A method as set forth in claim 13, wherein determining whether a destination module is configured to receive the value from the source module and implement the value in a control procedure to control the vehicle component includes:
determining whether a first destination module is configured to receive the value from the source module and implement the value in a first control procedure to control the vehicle component; and
determining whether a second destination module is configured to receive the value from the source module and implement the value in a second control procedure to control the vehicle component.

19. A method as set forth in claim 18, further comprising determining a priority of the first control procedure and the second control procedure based at least in part on the value from the source module.

20. A system comprising:
a first source module configured to generate a first value related to control of a vehicle component;
a second source module configured to generate a second value related to control of the vehicle component, wherein each of the first and second values are associated with a characteristic;
a first destination module configured to receive at least one of the first value generated by the first source module and the second value generated by the second source module and implement at least one of the first value and the second value in a first control procedure to control the vehicle component;
a second destination module configured to receive at least one of the first value generated by the first source module and the second value generated by the second source module and implement at least one of the first value and the second value in a second control procedure to control the vehicle component; and
a diagnostic tool configured to implement a diagnostic language that defines a compatibility relationship between one or more of the first source module, the second source module, the first destination module, and the second destination module, wherein the diagnostic tool is configured to determine whether at least one of the first value generated by the first source module and the second value generated by the second source module is compatible with at least one of the first control procedure and the second control procedure based at least in part on the characteristic of at least one of the first value and the second value and the compatibility relationship defined by the diagnostic language;
wherein the diagnostic tool is configured to determine whether the characteristic of at least one of the first value and the second value has changed, and if so, notify a user of at least one of the first destination module and the second destination module of the change;
wherein the diagnostic tool is configured to determine whether at least one of the first destination module and the second destination module is configured to receive the second value and determine that the second value is unnecessary if both the first destination module and the second destination module are not configured to receive the second value; and
wherein the diagnostic tool is configured to determine a priority of the first control procedure and the second control procedure based at least in part on at least one of the first value and the second value.
